(19) United States
(12) Patent Application Publication
(10) Pub. No.: US 2019/0147624 A1
(43) Pub. Date: May 16, 2019

(54) Method for Processing a Raw Image of a Time-of-Flight Camera, Image Processing Apparatus and Computer Program

(71) Applicant: Infineon Technologies AG, Neubiberg (DE)

(72) Inventors: Hannes Plank, Graz (AT); Norbert Druml, Graz (AT)

(21) Appl. No.: 16/185,362

(22) Filed: Nov. 9, 2018

(30) Foreign Application Priority Data
Nov. 10, 2017 (DE) 102017126378.0

(51) Int. Cl. G06T 7/80; G06T 7/50; G06T 7/20; G06T 7/11; H04N 5/225

(52) U.S. Cl. CPC G06T 7/80; G06T 7/50; G06T 2207/10028; G06T 7/11; H04N 5/2256; G06T 7/20

(57) ABSTRACT

One example of a method for processing a raw image of a time-of-flight (ToF) camera includes determining a phase-related value within a tracking region of the raw image and using calibration data to determine a distance corresponding to the phase-related value. One example furthermore includes a situation-dependent production of calibration data. One example shows how location tracking of an object, in particular with respect to its distance, is provided by the method. Further examples show an image processing apparatus of a ToF camera, a ToF camera, and a computer program product.

### TECHNICAL FIELD

Exemplary embodiments concern a method for operating a time-of-flight camera, or ToF camera for short, specifically a method for processing a raw image of a ToF camera. Further exemplary embodiments relate to an image processing apparatus for a ToF camera, to a ToF camera and to a computer program product for a ToF camera.

### BACKGROUND

A ToF camera can be used to produce a depth image. The respective distances of the imaged objects or parts of the imaged objects can be presented on this depth image. To this end, at least four individual recordings per depth image are produced in a phase-based distance determination. The individual recordings can be referred to as individual image or phase image or ToF raw image and be required for the reconstruction of the respective distances.

One light signal or light ray per raw image can be sent by the ToF camera or a light transmission unit or light source of the ToF camera, which is reflected by an object. The reflected signal is received with a phase shift or time shift that is dependent on the time of flight by the ToF camera or a light receiving unit of the ToF camera. The phase shift of the individual images can contain the information with respect to the distance of the respective objects, with the distance being ascertained by way of a combination of the respective individual images.

In particular when using ToF cameras in mobile devices, in which any electric power required for the ToF camera may be limited by a respective predetermined battery capacity, the recording of the respective individual images for creating a depth image can represent an energy requirement that is too great for a specified operating time of the mobile device. This may be a disadvantage especially when tracking the position of an object, for which depth images must be recorded continuously, because this results in a continuously great energy requirement. Furthermore, it is possible, due to the time period until the respective individual images have been successively recorded, for latency to arise that can lead to a delay in an image output of the ToF camera.

Known are methods for operating ToF cameras and for processing raw images of ToF cameras.

There is a need for a method for operating a ToF camera for tracking an object, by way of which even previously unknown objects can be tracked and which provides a reduction in an energy requirement and latency when tracking.

### SUMMARY

One exemplary embodiment relates to a method for processing a raw image of a time-of-flight (ToF) camera. The method comprises determining a phase-related value within a tracking region of the raw image and the use of calibration data to determine a distance that corresponds to the phase-related value.

A raw image which has been processed in accordance with the method can also be referred to as a phase image which has been recorded by the ToF camera with a single exposure. For example, a raw image can have been recorded based on exposure with modulated light of an individual phase position or an individual phase shift or an individual phase displacement. It is also possible for the phase position of the modulated light to be modified during the exposure.

Such a raw image has at least one tracking region, or it can have a plurality of tracking regions or be divided into such tracking regions. A tracking region can be, for example, a specific contiguous region within an object, the distance of which from the ToF camera is to be determined. The at least one tracking region has at least one phase-related value. A phase-related value can also be referred to as a phase value of the raw image or a value of an auto-correlation function between a light signal emitted by the ToF camera and a light signal received by the ToF camera.

A phase-related value of a tracking region can correspond to a distance to be determined of the tracking region from the ToF camera. Furthermore, calibration data are used or utilized to determine this distance. It is possible with the calibration data to assign for example the respective corresponding distance to a phase-related value. The distance thus determined can be the distance of the tracking region, within which the phase-related value is determined.

The method can have the effect that only one raw image is required to determine the distance. In this way it is possible to reduce an energy requirement of a ToF camera, in particular to reduce the energy requirement by up to 75%, for example, with respect to a conventional method for determining a distance. A ToF camera that is operated in this way can consequently be used, for example, for object tracking or object locating in a mobile device having limited energy storage. A further effect may be that in the case of a determination of a distance in accordance with the method a latency time is reduced because, instead of a plurality of raw images, only one raw image needs to be recorded by the ToF camera to determine the distance. In contrast to a distance determination using a depth image consisting of four raw images, a latency time can decrease by up to 75%. A further effect of the method can be that movement artefacts during the distance determination of moving objects can be completely avoided because only a single raw image is always required to determine the distance.

An exemplary embodiment is concerned with an image processing apparatus for a ToF camera. An image processing apparatus comprises an image reading device and a distance determination device. The image reading device is configured to provide a phase-related value within a tracking region of a raw image. The distance determination device is configured to determine a distance corresponding to the phase-related value by using calibration data. The image processing apparatus can receive at least one raw image from a ToF camera, or such a raw image can be available to the image processing apparatus.

The image processing apparatus can capture a tracking region of the raw image or ascertain or utilize a predetermined tracking region to ascertain and output, provide or store a phase-related value within the tracking region.

The image processing apparatus can furthermore determine a distance corresponding to the phase-related value using the distance determination device. Calibration data can be available in, or be made available to, the image processing apparatus or the distance determination device. The distance determination device can utilize the calibration data to assign a distance to the phase-related value that is provided by the image processing apparatus or to determine said distance. In accordance with a few further exemplary embodiments, the image processing apparatus can furthermore be set up to store or output the distance that was thus determined.

Further exemplary embodiments concern a ToF camera having an image processing apparatus and a computer program product. The ToF camera can have such an image processing apparatus or be combined with an image processing apparatus. Such a ToF camera can have the effect that, when locating an object at a 60 Hz frame rate for example, that is to say with 60 determined distances per second, an exposure time for producing a raw image at constant latency can be longer, in particular up to four times longer, than in the case of a ToF camera that requires for example four raw images for determining a distance. Due to the longer exposure time, a high signal-to-noise ratio can be ensured.

Further exemplary embodiments concern a computer program product. The computer program product has a program code that can effect performance of a method for processing a raw image of a time-of-flight (ToF) camera, in particular determining a distance, when the program code is executed on a programmable hardware component. Such a computer program product can furthermore have the effect that it is avoided that depth images composed of a plurality of phase images are produced in corresponding elaborate calculations. Owing to the computer program product, a CPU utilization can be reduced in the determination of a distance in some exemplary embodiments, which can save costs and energy.

### BRIEF DESCRIPTION OF THE FIGURES

A few examples of apparatuses and/or methods will be explained in more detail below merely by way of example with reference to the appended figures. In the figures:

FIG. 1 illustrates a schematic block diagram of a method for processing a raw image of a time-of-flight camera;

FIG. 2 illustrates a schematic diagram of a relationship between a phase-related value and a distance;

FIG. 3 shows an exemplary embodiment of a tracking function;

FIG. 4 shows examples of tracking regions used in an exemplary embodiment;

FIG. 5 illustrates a schematic block diagram of a method for generating calibration data;

FIG. 6 shows a schematic diagram of a relationship between phase-related values and a distance in dependence on a phase position;

FIG. 7 shows calibration data in accordance with an exemplary embodiment;

FIG. 8 shows extrapolation of calibration data in accordance with an exemplary embodiment;

FIG. 9 shows a schematic diagram of an example of a possible ambiguous assignment of a phase-related value to two distances;

FIG. 10 shows an illustration of a concept for an exemplary embodiment of a method for avoiding an ambiguous assignment;

FIG. 11 shows an exemplary embodiment of a method for selecting a suitable phase position; and

FIG. 12 shows an exemplary embodiment of an image processing apparatus for a time-of-flight camera.

### DETAILED DESCRIPTION

Various examples will now be described in more detail with reference to the appended figures, in which a number of examples are illustrated. In the figures, the thicknesses of lines, layers and/or regions may be exaggerated for clarification.

Further examples are suitable for different modifications and alternative forms, and consequently a few specific examples thereof are shown in the figures and will be described in detail below. However, this detailed description does not limit further examples to the described specific forms. Further examples can cover all modifications, correspondences and alternatives that fall within the scope of the disclosure. The same reference signs relate throughout the description of the figures to the same or similar elements, which upon comparison can be implemented identically or in a modified form, while providing the same or a similar function.

It is to be understood that where an element is referred to as being “connected” or “coupled” to another element, the elements can be connected or coupled directly or via one or more intermediate elements. When two elements A and B are combined using an “or,” this is to be understood to mean that all possible combinations are disclosed, i.e. only A, only B, and also A and B. An alternative wording for the same combinations is “at least one of A and B.” The same applies to combinations of more than 2 elements.

The terms used here to describe specific examples are not intended to be limiting for further examples. If a singular form, e.g. “a, an” and “the,” is used and the use only of a single element is defined as being neither explicitly nor implicitly binding, further examples can also use plural elements to implement the same function. When a function is described below as being implemented using a plurality of elements, further examples can implement the same function using a single element or a single processing entity. Furthermore, it is understood that the terms “comprises,” “comprising,” “has” and/or “having” when used concretize the presence of the indicated features, whole numbers, steps, operations, processes, elements, components and/or a group thereof, but do not exclude the presence or the addition of one or more further features, whole numbers, steps, operations, processes, elements, components and/or a group thereof.

Unless this is otherwise defined, all terms (including technical and scientific terms) are used here in their typical meaning of the field to which examples belong.

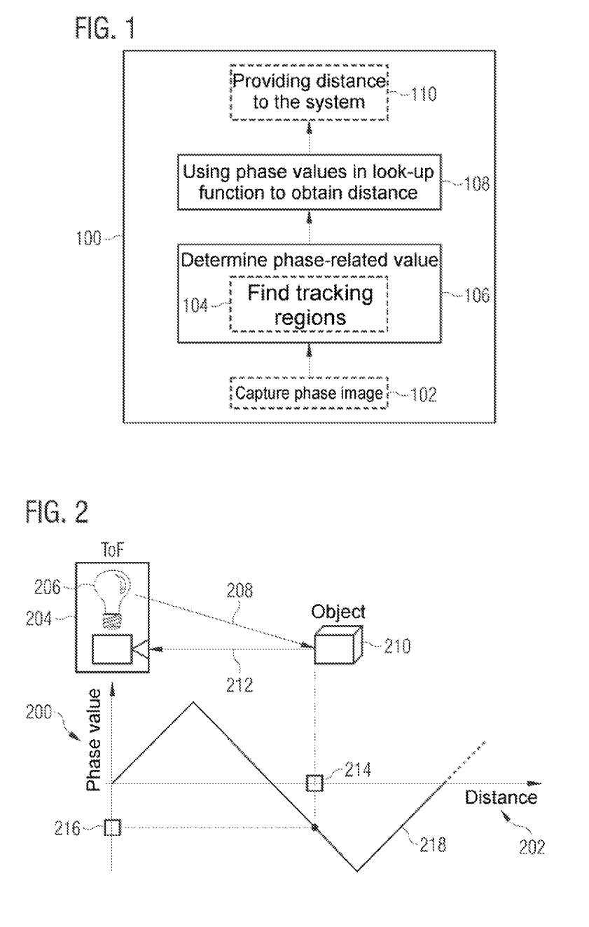

FIG. 1 illustrates a schematic block diagram of a method 100 for processing a captured raw image of a time-of-flight camera (ToF camera). In the exemplary embodiments described below, the ToF camera is what is known as a continuous wave ToF camera (CW ToF camera), in which the intensity of an emitted light is modulated with a light modulation signal that typically has a frequency in the kHz on MHz range. The light that is reflected by an object is demodulated in a demodulation pixel (e.g. a pixel of a photon mixing device (PMD)) of the ToF camera using a reference signal that has a rigid phase relationship with the light modulation signal for producing a raw image. Here, the reference signal is applied to the demodulation pixel and the photo-produced charge carriers are guided either to a first or second collection node in dependence on the phase shift between the incoming light signal and the reference signal. Obtained from the difference Q of the charges collected in the two collection nodes is the auto-correlation signal or, for a plurality of pixels, the raw image, which can also be referred to as a phase image. To produce a 3D image, the ToF camera then produces auto-correlation signals at predetermined different phase positions, i.e. at different phase shifts between the modulation signal and the reference signal. The plurality of auto-correlation signals are then correspondingly processed to calculate a phase difference φpd, which is produced by the time of flight of the light from the light source to the object and back. If for example charges Q1, Q2, Q3 and Q4 produced during 4 phase positions 0, 90°, 180° and 270° are obtained in the demodulation pixels, it is possible to ascertain the phase difference and consequently the distance of the object point via the equation arctan(φd)=(Q2−Q4)/(Q1−Q3).

In subsequently described exemplary embodiments it is possible, in contrast to the above-described method which produces and uses a plurality of raw images to calculate distance information or a 3D image, to produce in an additional operating mode distance information or a 3D image which requires only the recording of a single raw image, i.e. only a single phase shift between the modulation signal and the reference signal. To this end, at least one tracking region can be provided or selected in the raw image. The method 100 comprises determining a phase-related value 106 within the tracking region. The phase-related value can, for example, correspond to a value of the auto-correlation signal measured using a pixel of a ToF camera, which value can be referred to as a phase value and can have, for example, a specific intensity. The specific phase-related value 106 is utilized, using calibration data 108, to determine a distance.

Optionally, the raw image can be captured or provided in an image capturing step 102. The tracking region can be determined in the raw image in an optional tracking step 104. The specific distance can be output to a subsequent system in an optional output step 110.

FIG. 2 shows a schematic illustration of a relationship between a phase-related value 200 (phase value) and a distance 202 to illustrate the extent to which a phase-related value can correspond to a distance. A ToF camera 204 can have a light source 206, which illuminates the object 210 for example with periodically modulated light from the infrared spectrum 208. The ToF camera can ascertain, based on the light 212 that is reflected by the object 210, a phase-related value 200, which can be dependent, inter alia, on a distance 202 of the reflective object from the ToF camera. For example, the phase-related value can correspond to a received light intensity at predetermined reference times. For example, the reference times can be times at which the reference signal has a phase of n·360° (n=0,1,2 . . . ). The reference signal can be, for example, synchronous with respect to the intensity modulation signal with which the emitted light is modulated. The received light intensity at the predetermined reference times is thus dependent on a relative phase shift between the envelope of the emitted light and the envelope of the reflected light or is, for example, proportional thereto. The relative phase shift is dependent in turn via the modulation frequency of the light on the distance between a reflective region of the object 210 and the camera, as is illustrated schematically in FIG. 2.

The ToF camera 204 can be configured in a special exemplary embodiment such that it emits pulsed intensity-modulated infrared light and captures light that is reflected by an object or by a plurality of different objects in the image region using a PMD (photonic mixer device) image sensor. A PMD image sensor can be provided in each image point of the ToF camera 204 and produce a value in each case that indicates a phase shift difference between the emitted and received light. Owing to an auto-correlation of the emitted and received light it is possible, as described above, for a PMD image sensor to produce for each image point a phase-related value, e.g. an auto-correlation signal. Such an image consisting of phase-related values is also referred to, as described above, as a phase image or a raw image. A function 218 illustrated in FIG. 2 schematically illustrates the relationship between phase-related values 200 and distance 202.

If this fundamental illustration were considered alone, it would be possible to assign a distance to each phase-related value between the two maxima. However, the phase-related values ascertained by the ToF camera in an individual raw image frequently do not depend on the distance alone, but also on other factors, such as for example on the unknown reflectivity of the region of the object that is imaged on the respectively considered pixel. By using calibration data, it is possible for possible additional dependencies to be taken into account, such that, in accordance with some exemplary embodiments, the use of an individual raw image is sufficient to assign a distance to a phase-related value in connection with the calibration data.

This can be the case for example if the calibration data were determined for that tracking region for which the phase-related value is also determined. Possibilities for determining suitable tracking regions and for suitably determining calibration data that correspond thereto will be described with reference to a number of the subsequent figures.

A distance can be determined for example with respect to an extended tracking region on the object 210 or individually for each image point (pixel) of a sensor used in the ToF camera. In an exemplary embodiment, the tracking region can also be extended to the entire object 210 or comprise it, such that the resulting distance can be the distance of the ToF camera from the entire object 210. In the configuration illustrated by way of example in FIG. 2, the object 210 has a first distance 214 from the ToF camera 204. The ToF camera ascertains for this distance a first phase-related value 216, which corresponds to the first distance 214.

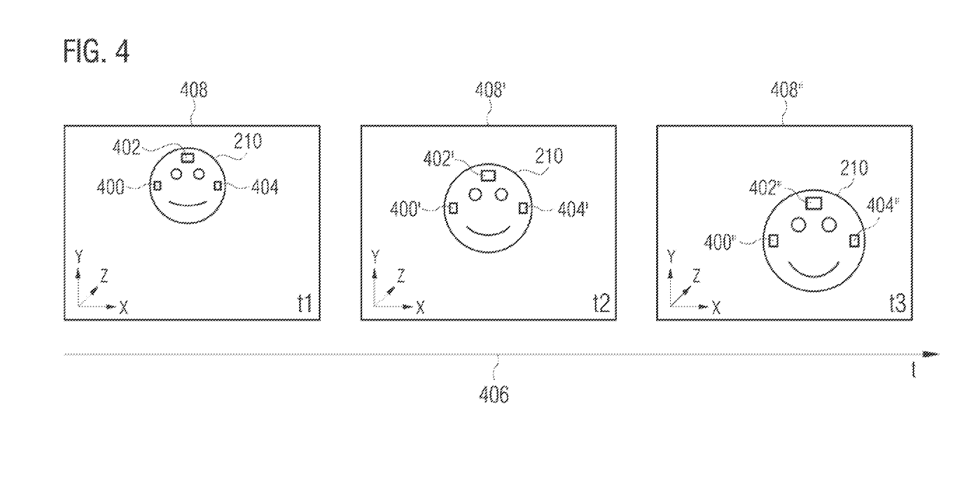

As was already mentioned in connection with FIG. 1, the method 100 for processing the raw image can in some exemplary embodiments also comprise capturing 102 of said raw image. The raw image can to this end be recorded and provided by the ToF camera 204. That is to say, the raw image can be recorded during the performance of the method 100 or can have already been recorded prior to it. For example, the ToF camera 204 can record or provide a raw image that presents the object 210 in an environment. In other cases, it is possible in addition to the object 210 for further objects to be imaged on the raw image at different distances. In accordance with the method, the tracking region on the raw image can be determined such that it completely or partially comprises the object 210. The tracking region can be ascertained for example by applying a 2D tracking method to the respective raw image. Raw images or phase images can be particularly suitable for such tracking because, for example, different distances of different objects can bring about different phase values in the raw image, which can then for example be differentiated from one another as an associated region. The image region of the raw image on which an individual object 210 is imaged can thus be identified for example as a tracking region. In accordance with further exemplary embodiments, an individual object can, however, also comprise a plurality of tracking regions, as will be explained for example with reference to FIG. 4.

To determine the phase-related value 106 within the tracking region, a phase-related value of an image point of the tracking region can be selected. For example, an image point located in the geometric center of the tracking region can be used herefor. To ascertain the distance of the tracking region and consequently of the object 210, it is possible to use the phase-related value with calibration data. Calibration data can have been generated previously, in particular for a respectively current image scene with the object 210. The calibration data can thus be adapted in each case to a recording environment. A possibility for generating calibration data will be described below. Calibration data can be available for example in the form of a look-up table, which can assign in each case a distance 202 to a respective phase-related value 200.

In the exemplary embodiment, the tracking region of the raw image comprising the object 210 can have the phase-related value 216. By using calibration data or a look-up table, it is possible to assign a distance 214 to this phase-related value 216. In this way, it is possible by simple placement of a single phase-related value 216 in for example a look-up table to determine the distance 214 of the object 210 from the ToF camera 204 or for an output 110 of the distance to be effected. Owing to the method, the distance determination can be quick, energy-efficient and possible with little calculation outlay.

In a special exemplary embodiment, an object 210 can be identified on a raw image, wherein the object 210 can be assigned a tracking region. The tracking region can have a phase-related value that can be assigned to a distance by way of calibration data. The distance can correspond to the distance of the object 210 from the ToF camera at the time of the recording of the raw image.

The method 100 can be used in particular with repeated performance to provide a tracking function which can ascertain in particular a respectively current or updated distance of the object. The object 210 can thus be tracked, or the location of the object 210 can be tracked. In particular, according to the method, 3D object tracking, or 3D tracking, is possible, which can comprise a distance of the object 210.

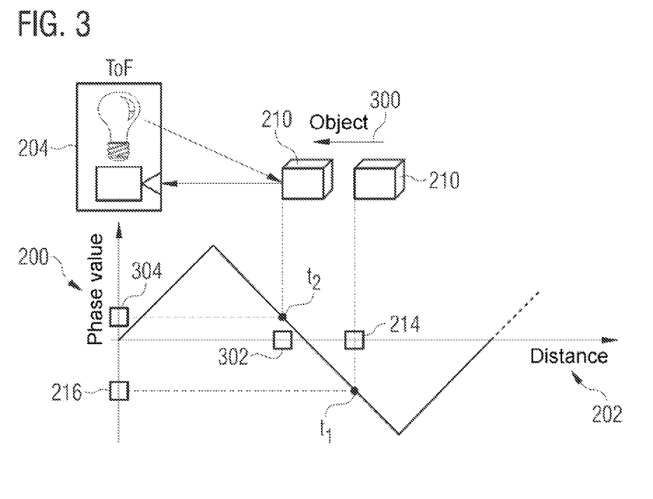

FIG. 3 shows an exemplary embodiment, in which a movement of an object 210 in a direction 300 can be tracked. With the ToF camera 204, a movement or change in the distance 202 of the object 210 from the ToF camera 204 can be captured or tracked. At a first time t1, for example the first distance 214 of the object 210 can be determined on the basis of the corresponding phase-related value 216 which is determined in accordance with the method. At a time t2, which can be situated after t1, for example, or can have occurred later than time t1, a second phase-related value 304 can be determined. The second phase-related value 304 can be ascertained from a raw image which may have been recorded at time t2 likewise by the ToF camera. Ascertainment is performed in particular within the same tracking region of the object 210. Between the times t1 and t2, a position of the object 210 can have changed. By using the calibration data 108, a second distance 302 can be ascertained or determined on the basis of the corresponding phase-related value 304. By processing a further raw image of the same object 210 at a later time t3 (not illustrated), a change in position of the object 210 can be continuously tracked or observed. Raw images can to this end be recorded at a frequency in a range from 1 Hz to 100 Hz, in particular 25 Hz or 60 Hz. A higher used frequency can result in 3D tracking being possible more accurately with respect to the time resolution of the position changes. A lower frequency can have the result that, due to the lower number of recorded raw images, an energy requirement of the ToF camera can be lower.

In accordance with a further exemplary embodiment, the method 100 comprises determining one or more tracking regions as contiguously identifiable partial regions, which are similar with respect to their reflection properties, of an object 210 that is imaged on the raw image. This can have the result that, in an object having a single identifiable partial region, said one partial region can be used as a tracking region, while in objects having a plurality of identifiable partial regions, for example one of said plurality of partial regions can be used as a tracking region.

FIG. 4 shows a face as an example of an object 210 within an exemplary series of raw images 408, 408′ and 408″. It is possible, for example, for three partial regions 400, 402 and 404 of the object 210 on each of the raw images 408, 408′ and 408″ to be identified or provided as tracking regions. The raw images 408, 408′ and 408″ are recorded in a time sequence 406 at times t1, t2 and t3. Between each recording time, the position of the object 210 can have changed both with respect to the distance from the ToF camera and also within the image plane or 2D position. For example, the ToF camera 204 can be unmoved while the object 210 can move, with respect to the orientation of the camera, toward the latter, that is to say a distance of the object 210 from the ToF camera 204 can decrease between t1 and t3. The object 210 can at the same time for example also move to the right.

The tracking regions 400 and 404 of the example shown in FIG. 4 are cheeks, and the tracking region 402 is a forehead. In the example shown, said tracking regions each reflect the light approximately uniformly or homogeneously. By way of example, this property can be used to identify or re-identify the respective tracking regions in the successive raw images, with the result that in each case the different calibration data that are assigned to the different tracking regions are used in the successive raw images. Such a region which is identifiable with respect to its reflection property can be simply captured for example by way of the amount of light, which is specifically reflected by it in each case, on the previously captured object 210 or each captured object. A region which is identifiable as a tracking region can in other exemplary embodiments likewise be an inhomogeneous region of the object 210.

In another exemplary embodiment, a further partial region can be a pair of glasses or sunglasses worn by the user. The effect can be in this case that this partial region is identifiable because it can differ strongly with respect to its reflection property, in contrast to the user's skin, which can comprise a remaining region of the object 210. Identification of such a partial region can thus be possible with simple means. Further partial regions 400 and 404 can also be earrings of the user which, similar to a pair of sunglasses, can have reflection properties which are distinguishable from the remaining region due to their surface or their material.

In some exemplary embodiments, as has just been shown, at least two tracking regions in the object 210 are determined. This can make it possible for the object 210 to be resolved in the manner of a relief with respect to its surface shape or plastic embodiment because it is possible via the respective phase-related value to assign in each case one distance per tracking region. It is thus possible, when the object 210 is a head, for the distance of a nose to be less than the distance of an ear. The flexible number of the tracking regions can have the effect that an application-adapted optimum number with respect to an object resolution and depending on the object type can be selected. A further effect can be that, in the case of at least two tracking regions, rotations of the object 210 can be established. For example, when the distance 110 of the first tracking region 400 between two raw images 408, 408′ is constant, but the distance of the second tracking region 402 varies, a rotation and the respective direction of rotation of the object 210 can be determined.

A further exemplary embodiment makes provision for a further tracking region on a further object that is imaged on the raw image to be determined. For example two different objects, for example a head and a hand of a user, can be imaged on the raw image. For example, the user can point his hand to the ToF camera. According to the method, a dedicated tracking region can be assigned in each case to the hand and to the head. This can have the effect that both the distance of the hand and the distance of the head can be determined. To this end, the respective phase-related values of the respective tracking regions of the respective objects can be used, with the use of calibration data that in each case correspond to the tracking regions, for determining the respective distances. It is thus possible, for example, to capture that a user changes the position of his hand, while the position of his head is unchanged. It is also possible to track two users independently of one another.

In a further exemplary embodiment, provision is made for the phase-related value at a single image point of the tracking region to be determined. In the exemplary embodiment, this can have the effect, in particular in the case of tracking regions having a large number of image points, of a great decrease in method outlay. For example, a central image point can be selected for determining the phase-related value to determine the distance of an object 210. It is also possible first for the distance of a plurality of image points of the tracking region of the raw image 408 to be determined and for that image point of the tracking region to be selected in subsequent raw images 408′, 408″ that has the shortest or farthest distance in the raw image 408.

In a further exemplary embodiment, the phase-related values of a plurality of image points of the tracking region are averaged, and the averaged phase-related value is used for the distance determination with the use of the calibration data 108 for the tracking region. This can have the effect that an average distance of the object 210 from the ToF camera can be determined. It can furthermore have the effect that, due to the average distance value and a maximum or minimum distance of the tracking region, which can be determined by way of a phase-related value of the tracking region which has an extreme value, an object unevenness of the object 210 can be determined.

In some exemplary embodiments, when determining the phase-related value, a correction term is taken into account that is dependent on a respective image point to which the phase-related value corresponds. Such a correction term can be applied to a phase-related value by way of a post-processing operation, in which the raw image can be post-processed. For example, intensity fluctuations of image points or pixels of the ToF camera can be compensated here in each case, or systematic sensor errors can be compensated. If, for example, a different phase-related value were generated with the same light incidence at a first image point than at a second image point, one of the two phase-related values can be adapted by way of the correction term, or both values can be corrected. It is also possible to introduce as the correction term a further correction factor, which compensates a different light incidence per image point due to an inhomogeneous illumination unit of the ToF camera. Such a further correction factor can have been ascertained during a production or in a test method of the ToF camera or of an image sensor of the ToF camera and is dependent on the image sensor and consequently adapted in each case specifically to the ToF camera. A correction term can at some image points of the image sensor also have the value zero, which means that a phase-related value is not post-processed if this is not necessary at the corresponding image point.

In some exemplary embodiments, calibration data are generated for the tracking region in dependence on a respective recording situation. For each tracking region of a raw image, in each case corresponding calibration data can be generated that can be appropriate for a current situation. If the object 210 is located with the tracking region at a first distance, or in a first distance region, from the ToF camera, first calibration data can be determined for example for the tracking region, with which data the distance of the object 210 can then be determined. If the object 210 is located with the tracking region at a second distance, or in a second distance region, from the ToF camera, second calibration data can be correspondingly determined for the tracking region which are appropriate for or correspond to the recording situation with the second distance. A recording situation can here be a position of an object within a predetermined region, in particular distance region, around the respective distance. It is also possible for example for respective calibration data to be generated for a plurality of tracking regions, which can be at different distances.

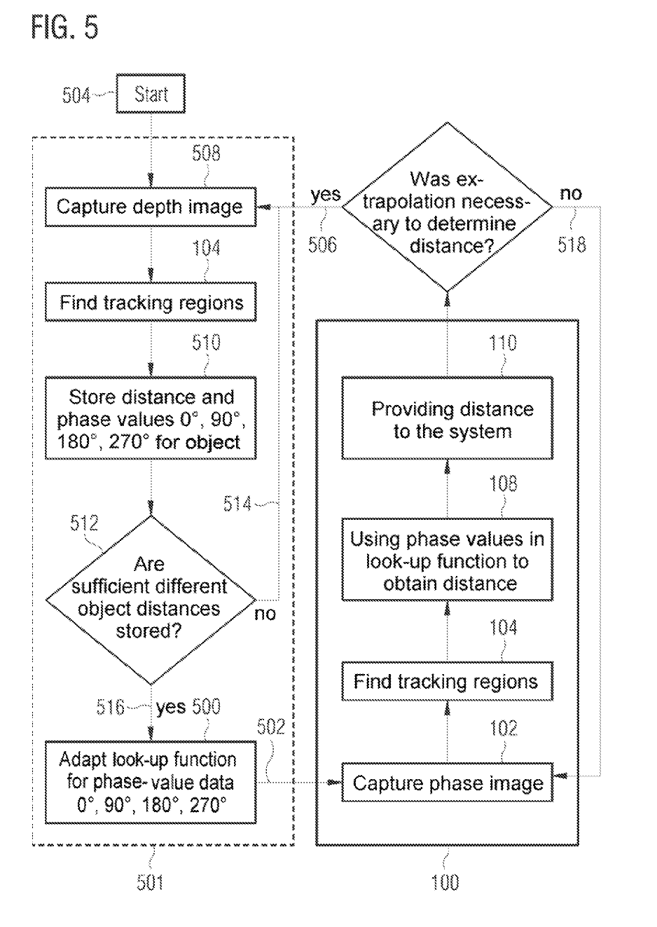

In this respect, FIG. 5 shows an exemplary embodiment of a generation 500 of calibration data which can be used in the method 100. For generating 500 or creating 500 the calibration data for at least one tracking region, a calibration 501 is performed for example after an initialization 504. During calibration 501, at least one depth image is captured, produced or generated from a plurality of raw images in one capturing step 508 or producing step 508. In some exemplary embodiments, a plurality of depth images are captured, that is to say the capturing step 508 is performed repeatedly in temporal succession. In the respective depth image, first the at least one tracking region is ascertained. For example, a depth image can be obtained in a typical manner in the capturing step 508 from four successive raw images of different phase positions, with the result that a depth image contains a distance value for each pixel of the two-dimensional sensor. The distance from the tracking region can therefore be ascertained in a known manner from each depth image thus produced. Storing 510 the distance thus ascertained together with a phase-related value provides a support point, which can also be referred to as a calibration data element, for the calibration data, which are based for each tracking region on a plurality of support points. The ascertained distance is stored in each case for the respective tracking region in combination with a phase-related value of one of the raw images as a support point. It is possible here to select the raw image with the desired phase position, because the depth image can be generated from a plurality of raw images with respectively different phase position. According to some exemplary embodiments, in each case one support point for phase-specific calibration data is generated in this step for each of the phase positions.

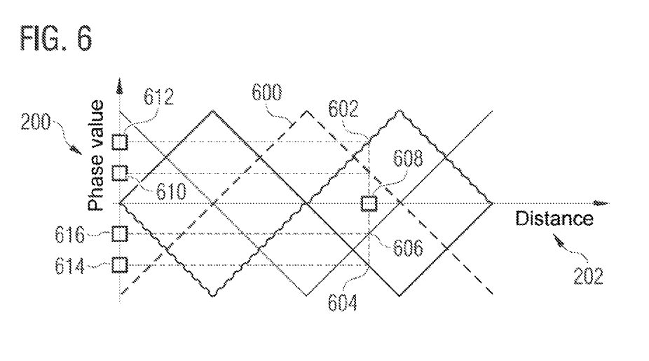

FIG. 6 shows a schematic illustration of phase-related values 200 of raw images of different phase positions 600, 602, 604 and 606, from which a depth image is generated in the process 501 in one exemplary embodiment. In the exemplary embodiment, a tracking region of the depth image comprising an object has a distance 608, in other words, the object is situated at a distance 608. The raw images have, depending on the phase position 600, 602, 604 or 606, a respective phase-related value for the tracking region. The phase positions 600, 602, 604 and 606 can here be distributed equidistantly to make possible capturing 508 of a depth image or to have any desired distances from one another. In one exemplary embodiment, the phase positions 600, 602, 604 and 606 can each have a distance of 90° from one another. The distance can also be less than 90°. In a special example, the phase positions 600, 602, 604 and 606 can have the respective values 0°, 90°, 180° and 270°. In further exemplary embodiments, the phase positions can have different values. The raw image having the phase position 600 has a phase-related value 610. The raw images with the phase positions 602, 604 and 606 have in each case a phase-related value 612, 614 and 616. A support point for calibration data for the phase position 600 is thus the phase-related value 610 in combination with the distance 608.

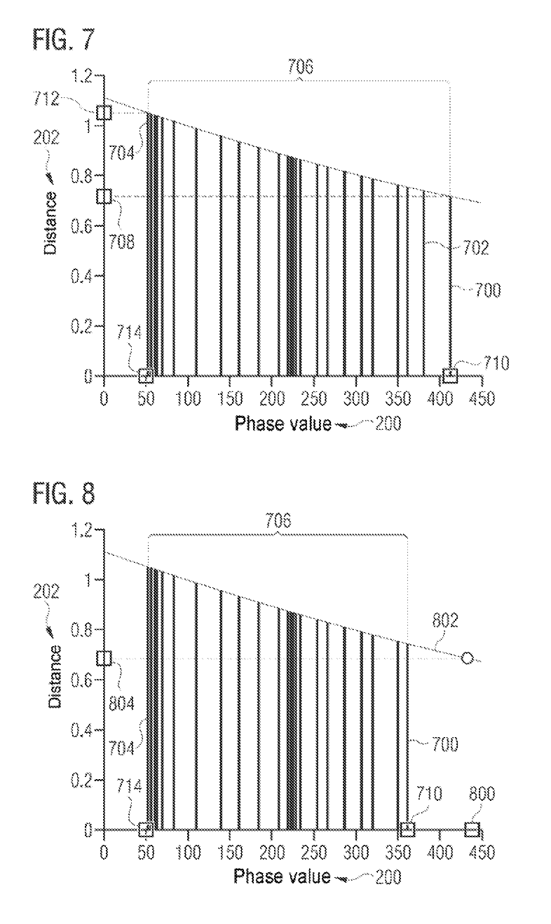

Calibration data can have a plurality of support points or calibration data elements, as is illustrated for example in FIG. 7. This can have the effect that the calibration data are valid for a larger distance region, in which a distance of an object can be determined by way of a raw image. In a test step 512 it is possible in one exemplary embodiment to decide using a stop criterion whether the calibration 501 is to be continued 514 in order to capture further depth images in the capturing step 508 for further storage 510, or whether a sufficient number of storage operations 510 has been performed, such that a termination 516 of the calibration 501 and a generation 500 of the calibration data, as is illustrated for example in FIGS. 7 and 8, can be performed because sufficient support points are available. After the termination 516, a generation 500 and a provision 502 of the calibration data for the method 100 can be effected. Provision 502 can, in a different exemplary embodiment, also be effected while the calibration 501 continues to be performed.

The calibration 501 can be started in different ways. In one exemplary embodiments, the calibration 501 is initialized 504 when an object is located in a new recording situation before the ToF camera 204. This can be the case when the object first appears in the image region of the ToF camera 204. Calibration data for the phase position 600 are generated, for example. The object is located at a first distance from the ToF camera, and the tracking region comprising the object has a first phase-related value. By combined storing 510, a support point for the calibration data is generated, which can be referred to as a calibration data element for the phase position 600. In the exemplary embodiment, the object moves during the calibration 501 in a region between the first and a second distance. Performed in the calibration 501 is a respective storing 510 of calibration data elements with a respective distance and a respective phase-related value of the tracking region. The calibration data elements are combined or generated to form calibration data. The thus generated calibration data are then valid for the tracking region in a region between the first and the second distance for the raw images of the phase position 600. In this way, it is possible for calibration data to be provided 502, with which raw images of the phase position 600 can be processed in the method 100. The calibration 501 can alternatively be started by a request 506 for example with respect to a post-calibration, as will be described below.

FIG. 7 shows calibration data elements 700, 702, 704 and further calibration data elements which have not been designated for the sake of clarity. The calibration data elements 700, 702, 704 can in combination form calibration data 706. The calibration data 706 in an exemplary embodiment assign in a predetermined region between a first and a second distance a specific distance 202 to a respective phase-related value 200. The calibration data element 700 for example assigns a first distance 708 to a phase-related value 710, the calibration data element 704 assigns a second distance 712 to a phase-related value 714.

In one exemplary embodiment, the calibration data 706 can include the calibration data element 700. In the method 100, it is thus possible to process a raw image of the first phase position with the phase-related value and to ascertain, by way of the calibration data element 700, the distance of the tracking region. However, since the phase-related value of a raw image in the method 100 can have different values, it can be necessary to be able to use respectively suitable calibration data herefor. Consequently, in some exemplary embodiments, at least a second calibration data element 704 is determined. It is ascertained for the same phase position as the calibration data element 700 in order to be able to thereby generate calibration data of this phase position. Performed to this end is capturing 508 of a second depth image of the object with the tracking region, for example when a distance of the object with respect to the ToF camera has changed. The second recorded depth image can also be used for the generation of the calibration data element 704 only when a distance change of the tracking region is established on the depth image. Otherwise, a further depth image which has a corresponding distance change can also be recorded and used. The distance of the tracking region of the object on the second depth image can correspond to a distance 712. The raw image of the second depth image having the first phase position can have a phase-related value 714 within the tracking region. The phase-related value 714 and the distance 712 can be stored in the calibration data element 704.

In the same way in one exemplary embodiment at least one further calibration data element 702 is additionally generated if a distance of the tracking region of the object 210 changes. The calibration data element 702 assigns a respective phase-related value to a distance between the first and the second distance. For example, it is thus possible to generate calibration data elements until a sufficient number of calibration data elements for the termination 516 is available. Such a number can represent for example a predetermined density of calibration data elements for a given distance region. For example, ten different calibration data elements can represent a sufficient number for a distance region of 50 cm. A sufficient number can also be specified in that in each case at least one calibration data element is available in each case at a distance of, for example, 10 cm or 2 cm within a given distance region for which calibration data should be applicable.

In a further exemplary embodiment, the first and the second calibration data element 700, 704 are stored together or in combination as calibration data 706, wherein further, for example 10 further or 100 further, calibration data elements are additionally stored. This can have the effect of an increased resolution of the calibration data 706. The calibration data elements 700, 704 can be stored in an interpolable look-up table presenting the calibration data 706. The look-up table can include for example between the calibration data elements 700, 704 five further or ten further or further calibration data elements. In one exemplary embodiment, it is possible in the method 100 to use a raw image with a phase-related value for which no calibration data element exists. If for a tracking region of a raw image to be processed a phase-related value is then ascertained which is for example not stored in the look-up table, it is nevertheless possible to ascertain a corresponding distance for said phase-related value. Herefor, the two calibration data elements with the phase-related values between which the phase-related value of the tracking region is located can be used, wherein the distances assigned thereto can be averaged or proportionally interpolated, and the result can be assigned to the missing phase-related value as a distance. The case may arise from an interpolable look-up table that there is no need to generate a calibration data element for each distance, but a finite number of calibration data elements 700, 702, 704 suffices to be able to assign a distance to a tracking region within a distance region of the calibration data 706.

Calibration data can also have a form other than a look-up table. In a further exemplary embodiment, a look-up function is adapted to the calibration data elements 700, 702, 704. This look-up function represents the calibration data 706. A look-up function can be, for example, a mathematical function or a third-order or higher-order polynomial which connects the respective individual calibration data elements with one another or continuously connects them with one another. It can be adapted at least within a distance region between the calibration data elements 700, 704 to the further calibration data elements 702 located between said calibration data elements. This can have the effect that calibration data 706 thus generated can make possible a particularly accurate assignment of distances, because a look-up function continuously covers the respective region of phase-related values 200. In particular in a lower-order look-up function, calculation of a respective distance 202 for a given phase-related value 200 can be effected quickly and efficiently, such that the distance of the tracking region can be provided in a simple manner.

In a further exemplary embodiment, the phase position of the calibration data 706 corresponds to said phase position of the raw image. The phase position of the raw image can be, for example, the phase position 600. What is meant hereby is that, when a raw image of the phase position 600 is to be analysed with respect to the distance of its tracking region, calibration data 706 of said same phase position 600 are used. These can be generated by the request 506, for example when the raw image of the phase position 600 is to be processed, or can have been generated possibly even before the recording of the raw image with the phase position 600. It is likewise possible that a raw image which is to be processed in accordance with the method is recorded with that phase position for which calibration data 706 are already available. This can have the effect that calibration data 706 do not need to be generated for all phase positions 600, 602, 604, 606 of the respective raw images of the depth images, but it may be sufficient for calibration data 706 to be generated for a single phase position 600 if only raw images of the phase position 600 are to be processed. In this way, the method can be performed particularly efficiently.

Provision is made in a further exemplary embodiment for a distance of the tracking region obtained from the depth image to be assigned to a phase-related value of a raw image of a different phase position 602, 604, 606. In this way, calibration data 706 can be generated for different phase positions 600, 602, 604, 606. It is thus possible for calibration data 706 for different phase positions to be available, such that raw images of the respective different phase positions can be processed immediately, without a request 506 for generating respective calibration data 706 being necessary. In some exemplary embodiments, calibration data 706 can be generated for a single further or for a plurality of further phase positions 602, 604, 606.

In a specific exemplary embodiment, it may be the case that the object moves out of a distance region of available calibration data. If the object for example is at a distance that is closer to the ToF camera than a distance that is stored in a calibration, for example the distance 708, a phase-related value of a tracking region exists outside of a validity region between the phase-related values 714 and 710 of the calibration data 706. For example, the phase-related value is then greater than the greatest phase-related value 710 of the calibration data 706. In an exemplary embodiment, the distance of said object can nevertheless be ascertained by using 108 the calibration data 706.

For this case, FIG. 8 shows an exemplary embodiment of a possible extrapolation 802 of calibration data 706. A phase-related value 800 can be greater than the phase-related value 710 and therefore no longer be covered by calibration data 706. It is nevertheless possible by way of the extrapolation 802, i.e. an expansion of the calibration data 706, or an expansion of the calibration data 706 as determined by calculation means, to determine a distance 804 for the phase-related value 800. For example, the phase-related value 800 can be determined in a simple manner if a look-up function is provided as the calibration data 706. In particular in the case of a lower-order look-up function, the latter can also be used outside its validity region without an error of a distance determination becoming noteworthy. It is also possible to perform the extrapolation 802 by way of a gradient between two data calibration elements 710, 714. For example by linearly connecting the two calibration data elements 710, 714, a straight line can be produced, the distance value 804 of which can be determined at the phase-related value 800. Owing to the extrapolation, it can also be possible for the stop criterion to already be fulfilled after a single storage 510 of a depth image 508, because the calibration data can be produced 500 by way of extrapolation of the single calibration data element. This can be effected in particular in the case of an initial generation 500 of calibration data, for example until further calibration data elements are available by a parallel continuation of the calibration 501. An extrapolation and a calibration can thus be effected in some exemplary embodiments in parallel.

In a further exemplary embodiment, if an object exceeds a validity region of calibration data, further calibration data elements are produced, that is to say a post-calibration is performed for the new recording situation. For example, it is possible at a distance 800 in the case of available calibration data 706 by way of the request 506 for the calibration 501 to be effected for the new distance region around the distance 800. It is possible here to continue to keep the original calibration data 706 available for example in a memory and to use them again when the object moves back into the distance region in which the calibration data 706 are valid. In one exemplary embodiment, extrapolation 802 of the calibration data 706 is effected until the post-calibration is at least partially complete.

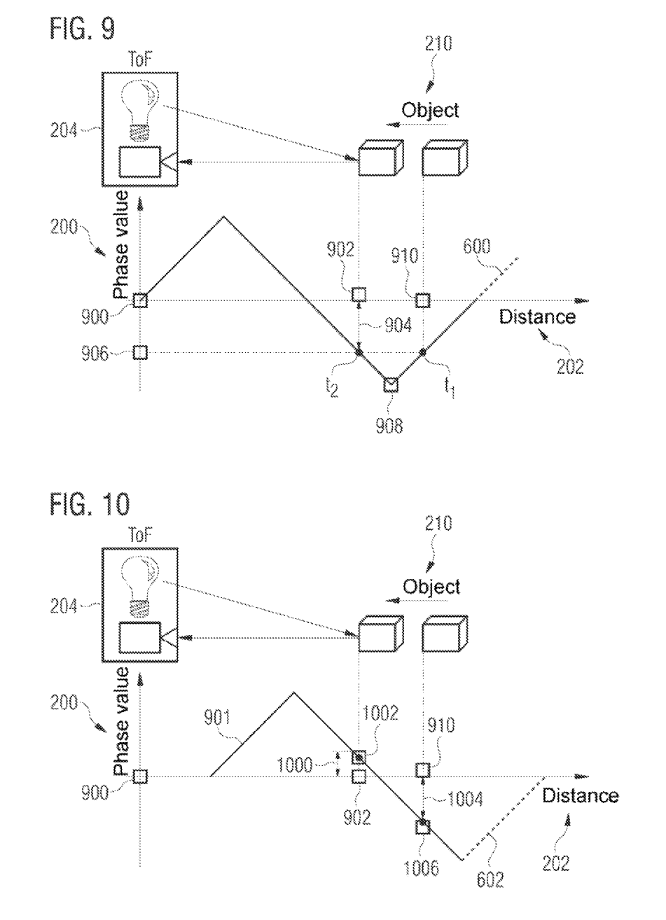

Owing to the production of raw images with modulated light, a phase-related value periodically changes in the case of a distance change of an object, with the result that the same phase-related value can be assigned to a plurality of distances. In one example, a possible result of said periodicity is that a phase-related value is ambiguous. In this respect, FIG. 9 shows a schematic diagram of such a case of a possible ambiguous assignment of a phase-related value to two distances. Phase-related values 200 can periodically assume values around a predetermined average value 900. This is illustrated schematically by a function 901, which assigns phase-related values 200 to in each case one distance 202. Hereby, it is possible to assign both a distance 902 and a distance 910 to the object 210 in the case of one phase-related value 906. This is possible in particular if the phase-related value 906 is close to an extreme point 908 or turning point 908, at which a monotonous change of the phase-related value is interrupted in the case of a distance change of the object. Since a phase-related value has a maximum distance from the average value 900 at the extreme point 908, this may be the case if a distance 904 of the phase-related value 906 from the average value 900 exceeds a predetermined value, because it is close to a border of a region in which the phase-related value changes monotonously in the case of a distance change. In one exemplary embodiment, the phase-related value 906 is determined with a raw image of the phase position 600.

FIG. 10 shows an exemplary embodiment, which allows for this ambiguous assignment for the same distances 902, 910 of the object 210 to be avoided. Provision is made here for the avoidance of phase-related values with a large distance from the average value 900. Shown distances 1000, 1004 of the phase-related values 1002, 1006 from the average value 900 are less than the distance 904. As a result, phase-related values 1002, 1006 can be located within a region in which the phase-related value changes monotonously in the case of a distance change and be far enough away from the extreme point 908 to avoid ambiguous distance assignments. This is achieved in that a raw image of a different phase position, for example the phase position 602, is used for determining the respective distance. By using the other phase position 602, for an unchanging distance of the object, a different phase-related value is obtained, which can be closer to the average value 900 than in the case of a raw image of the phase position 600. The distance 1000 can thus be less as compared to the distance 904 with an unchanging distance 902 of the object 210. In the exemplary embodiment, a raw image of a different phase position is used in a distance region that could lead to an ambiguous assignment of a distance when using a raw image of a first phase position.

In one exemplary embodiment, a raw image of a different phase position is used when the phase-related value 906 of the raw image of the first phase position fulfils a predetermined criterion. The predetermined criterion can be fulfilled for example when the phase-related value 906 is too close to the extreme point 908, that is to say has a smaller distance than a predetermined distance from the extreme point 908. For example, the predetermined distance can be the mean value between the phase-related value of the extreme point 908 and the average value 900.

In a further exemplary embodiment, provision is made for the predetermined criterion to be fulfilled when the phase-related value of the first raw image of the first phase position is greater than the phase-related value of a second raw image of a different phase position. For example, the tracking region of the object 210 has, when using the first raw image, a phase-related value 906, while the same tracking region of the same object 210 of the second raw image with another phase position that differs from the first phase position has the phase-related value 1002. The phase-related value 1002 is here closer to the average value 900 than the phase-related value 906. In this case, it is possible for the distance determination of the object 210 in subsequent methods 100 for raw images of the other phase position to be used.

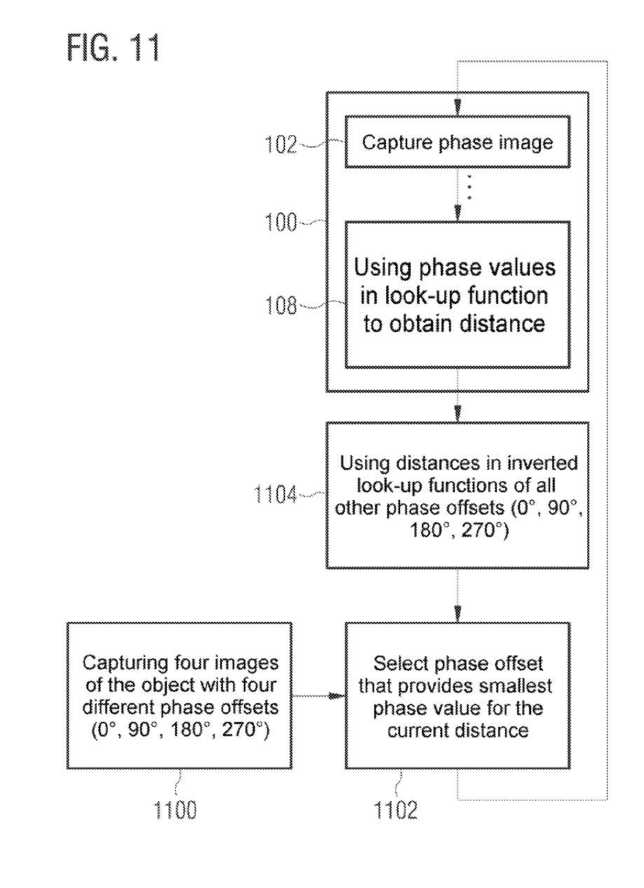

FIG. 11 shows an exemplary embodiment of a method for selecting a suitable phase position, with which ambiguous distance assignments are avoided. It is possible here for a selection 1102 to be effected of that raw image from a plurality of raw images which have been provided or made available by way of capturing 1100, which raw images can each have a different phase position 600, 602 from at least two phase positions, which provides for a distance a phase-related value that is closest to the average value 900. The selection 1102 is effected by determining a distance from a first raw image according to the method 100. By using 1104 at least two inverted calibration data of the at least two phase positions and the distance, at least two phase-related values from the at least two raw images of different phase position are determined. That is to say, while calibration data assign a distance to a phase-related value, inverted calibration data assign a phase-related value to a distance. The selection 1102 is effected for that phase position of the raw image whose phase-related value is closer to the average value 900. In other words, the phase-related value of a raw image of the selected phase position is located the farthest away from a boundary of a region in which the phase-related value monotonously changes in the case of a distance change.

In one example, a raw image of a first phase position 600 is used to determine a phase-related value 906, to which a distance 902 is assigned. The distance 902 can be incorporated in inverted calibration data of the first phase position 600 and a second phase position 602, with the result that a phase-related value per phase position 600, 602 can be ascertained, for example the phase-related value 906 and the phase-related value 1002. In the example, the phase-related value 1002 is closer to the average value 900 and as a consequence, the second phase position 602 is selected in the selection 1102. In subsequent methods 100, raw images of the phase position 602 can be processed and in this way ambiguous assignment of distances can be avoided. In order to select 1102 an optimum phase position 600, 602, 604, 606, it is possible in one exemplary embodiment for a plurality of inverted calibration data of different phase positions, in particular of four different or all available different phase positions 600, 602, 604, 606, to be used to select the phase position by way of which the phase-related value that is closest to the average value is obtained.

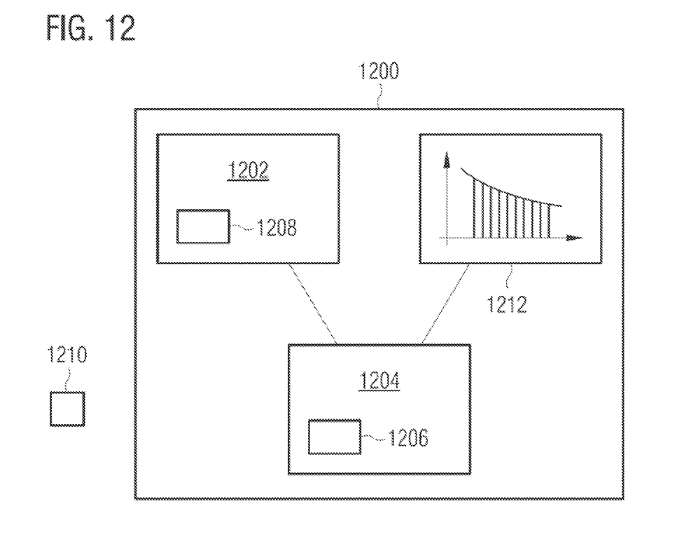

FIG. 12 shows an exemplary embodiment of an image processing apparatus 1200 for a time-of-flight camera 204. The image processing apparatus 1200 has an image reading device 1202, which is configured for providing a phase-related value 1208 within a tracking region of a raw image 1210. The raw image 1210 can be received by the image processing apparatus or be stored thereon. The image processing apparatus 1200 furthermore comprises a distance determination device 1204. The latter is configured to determine, using calibration data 1212, a distance 1206 that corresponds to the phase-related value 1208 and to thus make possible a distance determination of an object that can be imaged on the raw image 1210. The image processing apparatus can output the distance 1206 as information.

In one exemplary embodiment, the image processing apparatus 1200 can be attached to a ToF camera 204 or be connected thereto, in particular electrically connected for the purposes of signal transmission. The image processing apparatus 1200 can also be integrated in such a ToF camera 204.

In a further exemplary embodiment, a ToF camera 204 can have an image processing apparatus 1200. An image processing apparatus 1200 can be integrated in the ToF camera or be connected to the ToF camera. Such a ToF camera can be configured for the use in a mobile device or be installed in a mobile device.

A further exemplary embodiment can comprise a computer program product with a program code. The latter can effect a performance of the method 100 or of the generation 500 of calibration data in particular if it is installed on the ToF camera 204 or a mobile device with the ToF camera 204. The program code can effect the same if it is executed on the image processing apparatus 1200.

The examples show how the phase value or phase-related value of objects can be recorded together with distance measurements and can later serve as calibration data or look-up function to reconstruct depth or distance from individual phase images. Since ToF cameras provide all necessary input data, the system can adapt to new or changing objects during normal operation. When a number of depth measurements of the same object have been performed, the system can stop performing depth measurements for generating calibration data and instead simply use individual phase images. A simple look-up operation with respect to the phase response function learned in the calibration results in an assigned depth value or a corresponding distance. This can lead to a simple performance or performability with great accuracy.

An alternative possibility for generating calibration data can be an approach which is entirely based on machine learning, wherein such a system does not only learn the phase response function or calibration data of specific regions of an object, but also learns that of the complete object of the phase image or raw image per se in a structure, for example a neural network, which produces different distance values.

The aspects and features which are described together with one or more of the previously detailed examples and figures can also be combined with one or more of the other examples in order to replace an identical feature of the other example or in order to additionally introduce the feature in the other example.

Examples can furthermore be a computer program with a program code for performing one or more of the above methods or can relate thereto when the computer program is executed on a computer or a processor. Steps, operations or processes of different methods described above can be performed by programmed computers or processors. Examples can also cover program storage apparatuses, e.g. digital data storage media, which are machine-readable, processor-readable or computer-readable, and code machine-executable, processor-executable or computer-executable programs of instructions. The instructions perform some or all of the steps of the above-described methods or effect their performance. The program storage apparatuses can comprise or be e.g. digital memories, magnetic storage media such as magnetic disks and magnetic tapes, hard disk drives or optically readable digital data storage media. Further examples can also cover computers, processors or control units which are programmed for performing the steps of the above-described methods, or (field) programmable logic arrays ((F)PLAs) or (field) programmable gate arrays ((F)PGAs), which are programmed for performing the steps of the above-described methods.

Only the principles of the disclosure are illustrated by the description and drawings. Furthermore, all examples mentioned here are expressly intended in principle only to serve teaching purposes, so as to support the reader in understanding the principles of the disclosure and the concepts provided by the inventor (1) for further refining the technology. All statements made here relating to principles, aspects and examples of the disclosure and concrete examples thereof are intended to encompass the counterparts thereof.

A function block designated as “Means for . . . ” carrying out a specific function can relate to a circuit configured for carrying out a specific function. Consequently a “Means for something” can be implemented as a “Means configured for or suitable for something”, e.g. a component or a circuit configured for or suitable for the respective task.

Functions of different elements shown in the figures including those function blocks designated as “Means”, “Means for providing a signal”, “Means for generating a signal”, etc. can be implemented in the form of dedicated hardware, e.g. “a signal provider”, “a signal processing unit”, “a processor”, “a controller” etc., and as hardware capable of executing software in conjunction with associated software. When provided by a processor, the functions can be provided by a single dedicated processor, by a single jointly used processor or by a plurality of individual processors, some or all of which can be used jointly. However, the term “processor” or “controller” is far from being limited to hardware capable exclusively of executing software, but rather can encompass digital signal processor hardware (DSP hardware), network processor, application specific integrated circuit (ASIC), field programmable logic array (FPGA=Field Programmable Gate Array), read only memory (ROM) for storing software, random access memory (RAM) and non-volatile memory apparatus (storage). Other hardware, conventional and/or customized, can also be included.

A block diagram can illustrate for example a rough circuit diagram which implements the principles of the disclosure. In a similar manner, a flow diagram, a flow chart, a state transition diagram, a pseudo-code and the like can represent various processes, operations or steps which are represented for example substantially in a computer-readable medium and are thus performed by a computer or processor, regardless of whether such a computer or processor is explicitly shown. Methods disclosed in the description or in the patent claims can be implemented by a component having a means for performing each of the respective steps of said methods.

It is to be understood that the disclosure of a plurality of steps, processes, operations or functions disclosed in the description or the claims should not be interpreted as being in the specific order, unless this is explicitly or implicitly indicated otherwise, e.g. for technical reasons. The disclosure of a plurality of steps or functions therefore does not limit them to a specific order, unless said steps or functions are not interchangeable for technical reasons. Furthermore, in some examples, an individual step, function, process or operation can include a plurality of partial steps, functions, processes or operations and/or be subdivided into them. Such partial steps can be included and be part of the disclosure of said individual step, provided that they are not explicitly excluded.

Furthermore, the claims that follow are hereby incorporated in the detailed description, where each claim can be representative of a separate example by itself. While each claim can be representative of a separate example by itself, it should be taken into consideration that—although a dependent claim can refer in the claims to a specific combination with one or more other claims—other examples can also encompass a combination of the dependent claim with the subject matter of any other dependent or independent claim. Such combinations are explicitly proposed here, provided that no indication is given that a specific combination is not intended. Furthermore, features of a claim are also intended to be included for any other independent claim, even if this claim is not made directly dependent on the independent claim.

What is claimed is:

1. A method for processing a raw image of a time-of-flight (ToF) camera, the method comprising:
determining a phase-related value within a tracking region of the raw image; and
using calibration data to determine a distance corresponding to the phase-related value.

2. The method of claim 1, further comprising:
determining a partial region, which is identifiable with respect to its reflection property, of an object that is imaged on the raw image as the tracking region.

3. The method of claim 2, further comprising:
determining at least one further tracking region in the object that is imaged on the raw image.

4. The method of claim 1, further comprising:
determining at least one further object-specific tracking region in at least one further object that is imaged on the raw image.

5. The method of claim 1, wherein the phase-related value is determined at a single image point of the raw image in the tracking region.

6. The method of claim 1, further comprising:
averaging phase-related values, corresponding in each case to individual image points, of a plurality of or all image points of the tracking region to the phase-related value.

7. The method of claim 1, wherein a correction term that is dependent on a respective image point is taken into account in determining the phase-related value.

8. The method of claim 1, further comprising:
generating the calibration data for the tracking region in dependence on a current recording situation.

9. The method of claim 8, wherein generating the calibration data comprises:
producing a depth image from a plurality of auxiliary raw images of the current recording situation that are recorded in each case with a different phase position; and
assigning a distance of the tracking region, obtained from the depth image, to a phase-related value determined using an auxiliary raw image in the tracking region to obtain a first calibration data element for the phase position of the auxiliary raw image.

10. The method of claim 9, further comprising:
determining a second calibration data element for the phase position and the tracking region using a further depth image.

11. The method of claim 10, further comprising:
storing at least the first and the second calibration data element in an interpolable look-up table representing the calibration data for the phase position and the tracking region.

12. The method of claim 10, further comprising:
determining a look-up function, adapted to the calibration data elements, as the calibration data.

13. The method of claim 9, wherein the phase position corresponds to a phase position of the raw image.

14. The method of claim 9, further comprising:
assigning the distance of the tracking region, obtained from the depth image, to at least one further phase-related value determined by way of at least one of the remaining auxiliary raw images in the tracking region in order to obtain at least one further first calibration data element for the at least one further phase position of the respective auxiliary raw image.

15. The method of claim 1, further comprising:
extrapolating the calibration data when a phase-related value, ascertained by way of the raw image, exceeds a value range of the available calibration data.

16. The method of claim 15, further comprising:
producing further calibration data elements for distances corresponding to the extrapolated calibration data.

17. The method of claim 1, further comprising:
using a second raw image with associated calibration data when the phase-related value of the raw image fulfils a predetermined criterion, wherein the second raw image has a different phase position than the raw image.

18. The method of claim 17, wherein the predetermined criterion is fulfilled when the phase-related value of the raw image is farther away from a predetermined average value than a corresponding phase-related value of the second raw image.

19. The method of claim 1, further comprising:
generating at least two phase-related values using a current distance and at least two inverted calibration data which are different with respect to the phase position; and
using a raw image with the phase position with whose corresponding inverted calibration data that value of the at least two phase-related values was generated which is closest to a predetermined average value.

20. A time-of-flight camera, comprising:
an illumination device configured to emit intensity-modulated light in dependence on a modulation signal;
an image converter configured to receive intensity-modulated light that is reflected by an object, to demodulate the received intensity-modulated light using a reference signal and to produce a pixel measurement signal, wherein the image converter comprises an evaluation circuit configured such that, for a distance determination, a pixel measurement signal is used at only a single phase position between the modulation signal and the reference signal and is subsequently modified using calibration data.
